(19) United States
(12) Patent Application Publication
(10) Pub. No.: US 2023/0410027 A1
(43) Pub. Date: Dec. 21, 2023

(54) METHOD FOR ANALYZING AND ASSIGNING PROBABLE CAUSE TO SHOCKS EXPERIENCED BY SHIPPING CONTAINERS

(71) Applicant: Hitachi, Ltd., Tokyo (JP)

(72) Inventors: Lin MENG, San Jose, CA (US); Arnab CHAKRABARTI, Milpitas, CA (US)

(21) Appl. No.: 17/841,522

(22) Filed: Jun. 15, 2022

(51) Int. Cl. G06Q 10/08

(52) U.S. Cl. CPC G06Q 10/0832

(57) ABSTRACT

The world's cargo is transported in shipping containers. Historically, there has been little visibility into cargo once it goes inside a container. Breakable cargo, such as glass, is sometimes damaged in shipping. Sensors can be used to measure shocks experienced by the container in transit. The present disclosure presents systems and methods for analyzing such shocks into shock clusters and outliers. The present disclosure also proposes a way to assign probable cause to the shocks in each cluster based on prior knowledge of shock causes. The nature of shock data presents nuances that contribute to the uniqueness of the example implementations herein.

### BACKGROUND

### Field

The present disclosure is generally directed to shipping container systems, and more specifically, to systems and methods for analyzing and assigning probable cause to shocks experienced by shipping containers.

### Related Art

FIG. 1 illustrates an example of a shipping container. Such shipping containers are used to carry cargo all across the world. In the related art, there has been little visibility into cargo once it goes inside a container. Breakable cargo, such as glass, is sometimes damaged in shipping. If breakage can be monitored in real-time, it can facilitate faster shipping of replacements, faster insurance payouts, parametric insurance products and such.

In related art implementations, there are systems and methods that deal with verifying the state of an item during transit. Such related art implementations describe how data can be collected and transmitted for tracking state; however, this state is generic.

### SUMMARY

When fragile cargo breaks in transit, the stakeholders (manufacturer, shipper, and insurer) all want to know how and why it broke. Placing a shock sensor in a container is a first step as it records shocks. However, such shock sensors do not record the cause, nor is it clear which shock or collection of shocks are likely associated with the damage.

To address such issues, example implementations described herein are directed to systems and methods that analyze shocks into “clusters of similar shocks” and “outliers that stand out from other shocks”. It also associates one of several known causes with shocks. In this way, the example implementations described herein facilitate an understanding as to what likely happened inside the container. Such understanding can aid reasoning by a human risk expert and can contribute to the development of countermeasures that can reduce the incidence of damage in future shipments.

Aspects of the present disclosure can involve a method, involving, for receipt of a plurality of sensor data points associated with one or more sensors of a shipping container, each of the plurality of sensor data points representative of one or more shock measurements at a particular time, executing the clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and labeling the one or more clusters and the outliers with an associated shock cause based on a comparison of probability density functions of the one or more clusters and the outliers with historical probability density functions associated with shock causes.

Aspects of the present disclosure can involve a computer program, storing instructions involving, for receipt of a plurality of sensor data points associated with one or more sensors of a shipping container, each of the plurality of sensor data points representative of one or more shock measurements at a particular time, executing the clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and labeling the one or more clusters and the outliers with an associated shock cause based on a comparison of probability density functions of the one or more clusters and the outliers with historical probability density functions associated with shock causes. The computer program can be stored on a non-transitory computer readable medium and executed by one or more processors.

Aspects of the present disclosure can involve a system involving, for receipt of a plurality of sensor data points associated with one or more sensors of a shipping container, each of the plurality of sensor data points representative of one or more shock measurements at a particular time, means for executing the clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and means for labeling the one or more clusters and the outliers with an associated shock cause based on a comparison of probability density functions of the one or more clusters and the outliers with historical probability density functions associated with shock causes.

Aspects of the present disclosure can involve an apparatus, involving a processor, configured to, for receipt of a plurality of sensor data points associated with one or more sensors of a shipping container, each of the plurality of sensor data points representative of one or more shock measurements at a particular time, execute the clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and label the one or more clusters and the outliers with an associated shock cause based on a comparison of probability density functions of the one or more clusters and the outliers with historical probability density functions associated with shock causes.

### BRIEF DESCRIPTION OF DRAWINGS

FIG. 1 illustrates an example of a shipping container.

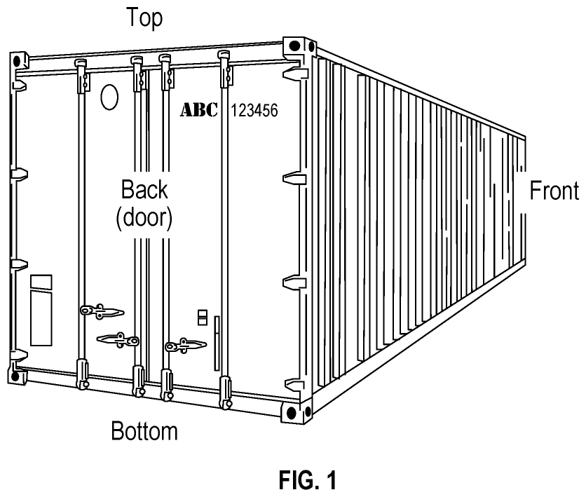

FIG. 2 illustrates an example shock vector and its components, in accordance with an example implementation.

FIG. 3 illustrates example segments of a journey, in accordance with an example implementation.

FIG. 4 illustrates an example of shock clusters and outliers.

FIG. 5 illustrates an example overall flow, in accordance with an example implementation.

FIG. 6 illustrates an example flow of the pre-processing block, in accordance with an example implementation.

FIG. 7 illustrates an example flow of the shock cluster identification block, in accordance with an example implementation.

FIG. 8 illustrates an example flow for probable cause identification, in accordance with an example implementation.

FIG. 9 illustrates example management information for the sensor data of a shipping container, in accordance with an example implementation.

FIG. 10 illustrates a system involving a plurality of shipping containers networked to a management apparatus, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The following terms are utilized to assist in explanation of the present disclosure.

Shock units: Shocks are measured in multiples of G (acceleration due to gravity, which is ˜9.81 m/s²).

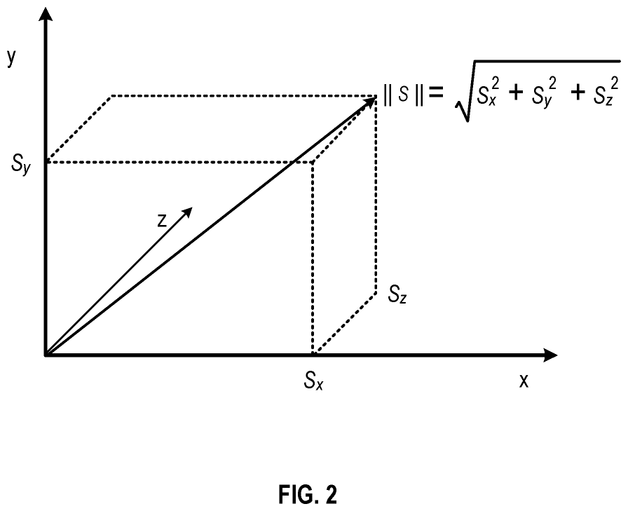

Shock direction: Containers are transported by following some simple conventions of orientation. The “top” face of the container always serves as the roof and is at the top. The “bottom” serves as the floor. The “door” is on the back for ease of unloading cargo when the container is, e.g., on a truck. These conventions determine the alignment of the container with reference to gravity and the direction of transport. FIG. 2 illustrates an example shock vector and its components, in accordance with an example implementation. Each shock is a three-dimensional vector with x, y, and z components as shown in FIG. 2. Its frame of reference is the container, meaning that the x, y, z directions are in relation to the position of the container at the time of shock recording. For example, the x-axis may correspond to the vertical (up-down) direction, the y-axis to the lateral (left-right) direction, and the z-axis to the longitudinal (forward-backward) direction. Signs are also taken into consideration. For example, a positive x-component might mean a shock in the direction of gravity, i.e., the container was dropped. In this way, if the x, y, z components of a shock are known, the size of the shock and what direction the shock came from can thereby be derived.

Each shock is associated with a timestamp indicating when it occurred.

Shock cause: Every shock has a cause. While the shock is measurable though a sensor, its cause is not recorded. Nonetheless, the notion of cause forms the basis for the example implementations described herein.

Journey segments: the time on a journey can be conceptually divided into segments. A segment is either a continuous part of the journey characterized by a single mode of transport (e.g., truck, ship etc.), or a part of the journey where time is spent between one mode of transport and the next (e.g., transfer from truck to ship). Journey segments are utilized so that shocks on any one segment can be attributed to a small set of causes. For example, on a truck, shocks can be attributed to braking, acceleration, turns, bumps on the road, and a few other causes. There may also be a rare few outlier shocks that can be attributed to unusual events such as accidents. The example implementations described herein analyze and assign probable cause to shocks, which can be granularized on a per-segment basis rather than for the entire journey if so desired. This is because shocks on different segments, even those that look similar statistically, can have different causes. The task of teasing apart shocks due to more causes is both harder and requires more data. For this reason, although the method itself can be applied to any set of shocks, it may perform better per-segment than over the whole length of a journey. It is therefore acceptable to aggregate shocks for the same segment across different shipments. Doing so allows example implementations to utilize a larger amount of data, which helps example implementations generalize better while enabling better shock characterization. The implicit assumption is that different shipments experience shocks from the same underlying causes while on the same segment of the journey.

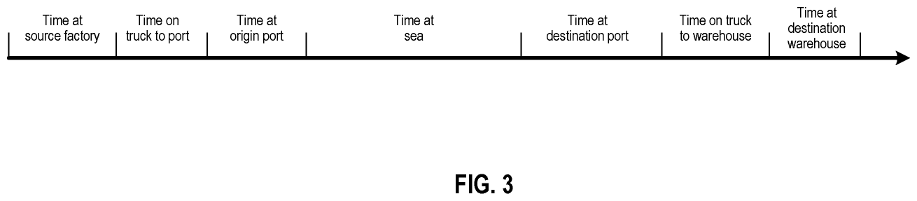

FIG. 3 illustrates example segments of a journey, in accordance with an example implementation. Examples of segments that can occur during the transport of a shipping container can include, but is not limited to, time at source factory, time on truck to port, time at origin port, time at sea, time at destination port, time on truck to warehouse, and time at destination warehouse, but is not limited thereto and can be set in accordance with any desired implementation.

Shock cluster: A cluster of shocks is a collection of multiple shocks associated with the same cause. These shocks are “near” each other using some notion of distance between shocks. Metrics for measuring distance between shocks are introduced next.

Metrics for Measuring Distance between Shocks

The proposed example implementations measure how close or far two shocks are. Suppose that there are two shocks s and t with components (sₓ, s_{y}, s_{z}) and (tₓ, t_{y}, t_{z}) respectively. The following distance metrics come into play.

Euclidian distance: Euclidian distance is a very common and intuitive metric for measuring distance between 3-D vectors. The metric is defined as:

d_{Euclidian}(s, t)=\sqrt{(sₓ−tₓ)²+(s_{y}−t_{y})²+(s_{z}−t_{z})²}

Mahalanobis distance: The Mahalanobis distance is not between two shocks, but rather between a shock S and a distribution D. It represents how many standard deviations away S is from the mean of D. Given a shock vector s, a cluster centroid μ_{C}, and cluster covariance matrix S_{C}, it is defined as:

D_{M}(s,C)=\sqrt{(s−μ_{C})^{T}_{C}⁻¹(s−μ_{C})}

Rocking distance: It is common for cargo to rock sideways on some segments, such as on ships, trucks, or trains. On these segments, shocks along the +y and −y directions correspond to the same cause—rocking. It makes more sense to ignore the sign of the y-component in defining shock clusters. In Euclidian space, such shock clusters will appear separated in two parts. The metric is defined as:

d_{Rocking}(s,t)=\sqrt{(sₓ−tₓ)²+(|s_{y}|−|t_{y}|)²+(s_{z}−t_{z})²}

where |s_{y}| and |t_{y}| are the absolute values of the y-components.

For purposes of clustering, this is equivalent to working with Euclidian distance on modified shocks (sₓ, |s_{y}|, s_{z}) and (tₓ, |t_{y}|, t_{z}) where the sign of the y-shock component is ignored.

Unit-norm distance: It is possible for a cause to produce numerous shocks of widely varying magnitudes all acting in the same direction. An example can be shocks due to braking. In these cases, it makes sense to strip shocks of their magnitude and focus only on the direction. This distance metric is the distance between unit vectors pointing in respective directions:

$${d}_{Unit - norm} ( s , t ) = {d}_{Euclidian} ( \frac{s}{‖ s ‖} , \frac{t}{‖ t ‖} )$$

Here, ∥s∥=d_{Euclidian}(s, 0). As the formula shows, this is equivalent to working with Euclidian distance on magnitude-normalized shocks s/∥s∥ and t/∥t∥.

As the discussion above reveals, different distance measures work well in different contexts, and can be utilized in accordance with the desired implementation.

Example implementations described herein are directed to shocks in the context of shipments. Clusters of shocks can be separated out in the presence of outliers, and causes can be assigned based on prior knowledge.

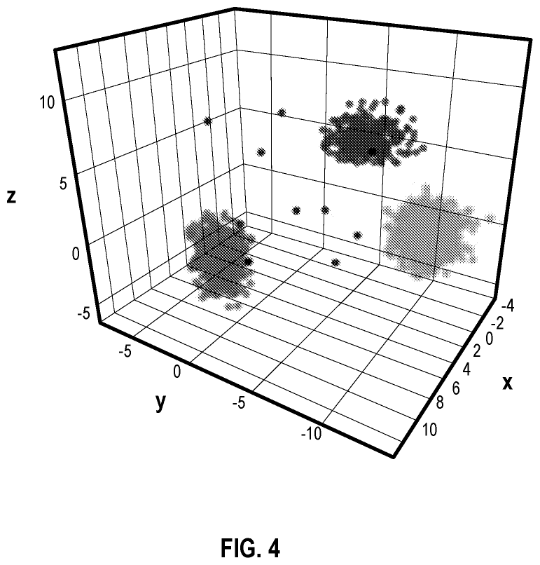

In view of the shock cause as determined herein, the shocks in a segment are a mixture of shock clusters and outliers. Shock clusters are groups of shock vectors associated with the same cause. FIG. 4 illustrates an example of shock clusters and outliers. In the example of FIG. 4, there are three clusters and ten outliers.

In FIG. 4, shock clusters are seen as 3-D Gaussian clouds. Each shock cluster is associated with a single cause. Example implementations described herein accept a set of 3-D shock vectors as input. The example implementations separate out the shocks into clusters and outliers and assign a likely cause to each cluster and outlier. The choice of distance metric (e.g., Euclidian, Rocking, or Unit-sphere) determines the preprocessing. The number of causes on a segment of the journey is not known beforehand, and determining this number is one of the challenges addressed by the present disclosure.

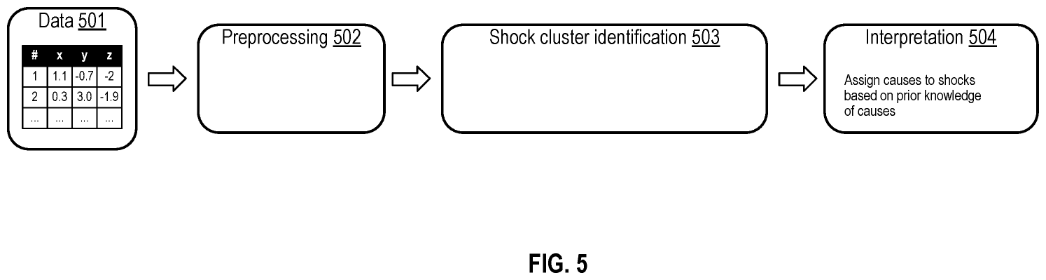

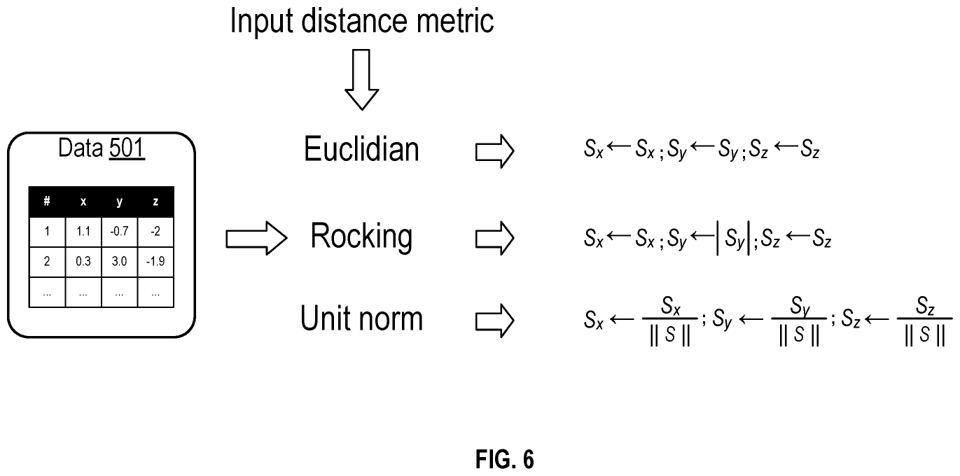

FIG. 5 illustrates an example overall flow, in accordance with an example implementation. The description of FIG. 5 is provided in context with the flows of FIGS. 6 to 8 as follows.

FIG. 6 illustrates an example flow of the pre-processing block 502, in accordance with an example implementation. The pre-processing block 502, expanded in FIG. 6, takes each shock vector from data 501 and transforms the shock's components to reflect the distance metric chosen for clustering. With Euclidian distance, the shock vectors require no modification. With rocking distance, the y-component is replaced by its absolute value. With unit-norm distance, each shock component is normalized by the magnitude of the shock vector. The choice of distance metric is left to user discretion based on the desired implementation. The example implementations work regardless of the distance metric chosen.

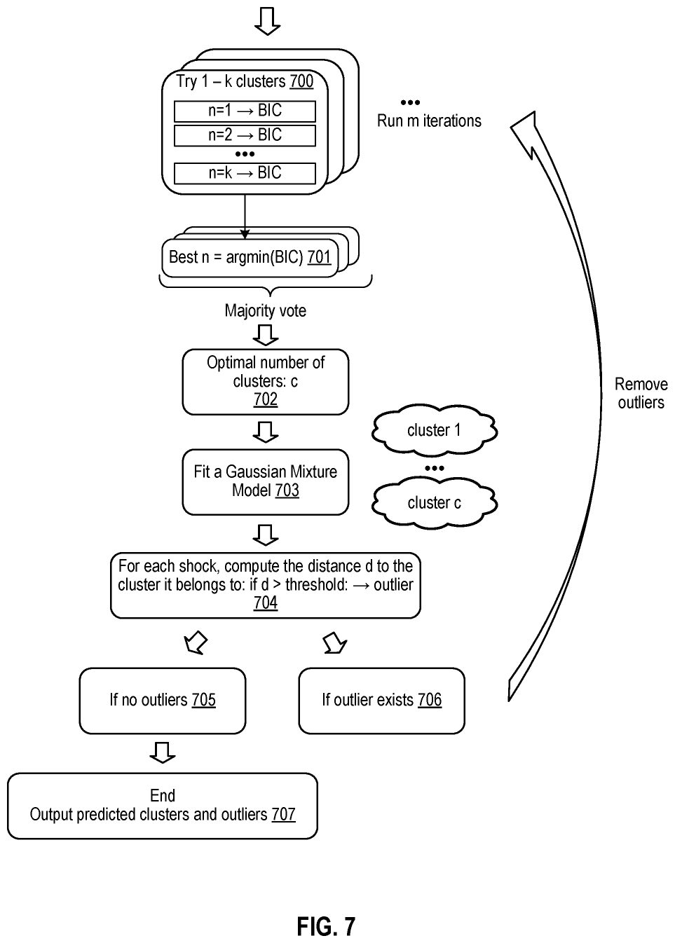

Next comes the “shock cluster identification” block 503, which is an iterative use of a clustering and distance thresholding to identify shock clusters and outliers. FIG. 7 illustrates an example flow of the shock cluster identification block, in accordance with an example implementation. This is depicted in the flow of FIG. 7. The method depicted here has two main aspects. In a first aspect, there are flows that help determine the optimum number of clusters, since this is not known. In a second aspect, there are other flows that identify the clusters themselves and remove outliers.

In the first aspect, the flows identify shock clusters when the number of clusters is known. In FIG. 7, these are the flows below “Optimal number of clusters: c” 702, e.g., flows at 703 to 707. In these flows, a Gaussian mixture model is fit to the shock data ensemble at 703. However, it is known that there may be large outlier shocks, e.g., due to accidents, that can distort clusters. Since the premise of a Gaussian mixture model is that a cluster resembles a Gaussian cloud, one can use knowledge of the Gaussian density to calculate the probability that a given shock belongs to a cluster based on the distance at 704. The distance represents the probability that the shock and the cluster belong to a common shock cause. If the distance from the probability distribution function exceeds a threshold as set in accordance with the desired implementation, then such a shock can be determined as an outlier. For example, for a given shock, if this probability is below a threshold (correspondingly, the Mahalanobis distance to the cluster is above a threshold), then the shock is labeled an outlier and removed from the clustering ensemble at 706. Clustering is then repeated with outlier shock(s) removed. The process repeats until no more outliers are found as shown at 705, whereupon the predicted clusters and outliers are produced as the output at 707. In this illustrative example, the “distance to the cluster” referred to in FIG. 7 is Mahalanobis distance.

In reality, the number of clusters c may not be known. To address this potential issue, the flow in FIG. 7 includes flows that simultaneously identify the optimum number of clusters c and the clusters and outliers themselves. Next, such flows to identify the optimum cluster count are described herein. The flows use the Bayes Information Criterion (BIC) to identify the optimum number of clusters. BIC is computed for 1,2, . . . ,k clusters where k is the maximum possible cluster count at 700. The value of k is dictated by the maximum number of causes of repetitive shock that cargo can reasonably experience over a given segment. The cluster count for which BIC is the least is the optimum cluster count. Cluster determination being a process dependent on the initial seed, the optimum cluster count is determined iteratively, and the number that comes up the most times at 701 is used as the optimum number of clusters.

Next comes the “interpretation” block at 504. Interpretation refers to probable cause identification. The interpretation block 504 assigns causes to shocks based on prior/historical knowledge of causes.

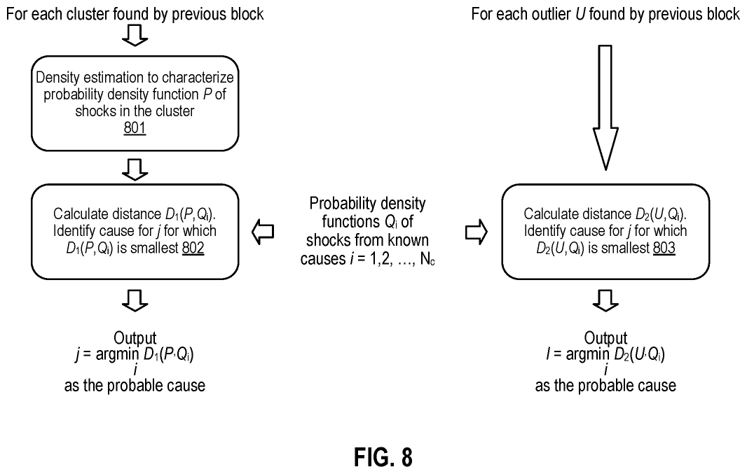

FIG. 8 illustrates an example flow for probable cause identification, in accordance with an example implementation. The process is slightly different for clusters and outliers. For clusters, first the probability density function is estimated for shocks in the cluster at 801. Then, this density function is compared with the density functions corresponding to shocks of all known causes at 802. The distance metric (equivalently, measure of similarity) for comparing two probability density functions is D₁. It is assumed that the probability density functions of shocks due to each cause are known. The cause, whose density is nearest to the cluster density is identified as its probable cause.

There are numerous density estimation techniques in the related art, and there are also many measures of similarity between probability densities. The flows in FIG. 8 can be applied using any combination of density estimation and measures of similarity between pairs of probability distributions. For example, clusters can be thought of as Gaussian, and parametric density estimation can be used to estimate the density parameters (mean and covariance matrix) for each cluster. Probability density functions of causes can likewise have parametric representations. The distance between pairs of distributions can be found, e.g., by the Bhattacharya distance, and the cause whose distribution is closest to a shock cluster can be assigned as that cluster's probable cause.

With outliers, the key difference is that the outlier is a single shock, which obviates the need for cluster density estimation. The distance metric D₂ measures the distance between an outlier and cause probability densities at 803. An example of such a distance metric is the Mahalanobis distance, although the flows shown should apply to any measure of distance between a point and a probability density. The cause corresponding to the cause density nearest to the said outlier is assigned as the probable cause of the outlier.

Causes that lead to clusters of shocks are not necessarily the same as causes that lead to outliers. While all causes are combined and represented by densities Qᵢ, in FIG. 8, separating out cluster versus outlier causes may lead to improved performance. In rare cases, a new type of shock may be encountered, which is not represented in the set of densities Qᵢ. In such cases, a human expert may choose to expand the set of known causes by calculating the new cause's shock distribution and including in the appropriate set of causes.

Accordingly, the example implementations presented here provide intuition and insight on the shocks felt on a journey. The example implementations do so by analyzing shocks into “clusters of similar shocks” and “outliers that stand out from other shocks”. The example implementations also assign probable cause to clusters and outliers. In this way, the example implementations lead to an understanding of what likely happened inside the container. Such understanding can aid reasoning by a human risk expert and can contribute to the development of countermeasures that can reduce the incidence of damage in future shipments.

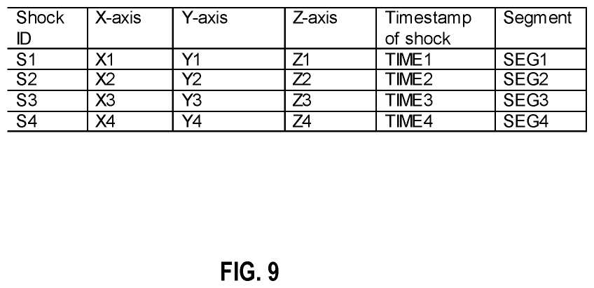

FIG. 9 illustrates example management information for the sensor data points of a shipping container, in accordance with an example implementation. Sensor data points indicative of shocks are provided to a management apparatus, which can parse the sensor data points as management information for each shipping container. Such management information can include the shock identifier, the x-axis measurement, the y-axis measurement, the z-axis measurement, the timestamp of the shock, and the corresponding segment of the journey of the shock, Shock identifier is the identifier assigned to the shock. The x-axis, y-axis, and z-axis measurements are stored as a vector of the shock measurement. The timestamp of the shock indicates the time that the shock occurred. Depending on the desired implementation, such a timestamp can be used to retrieve the corresponding segment, which can be used as the segment label for the shock.

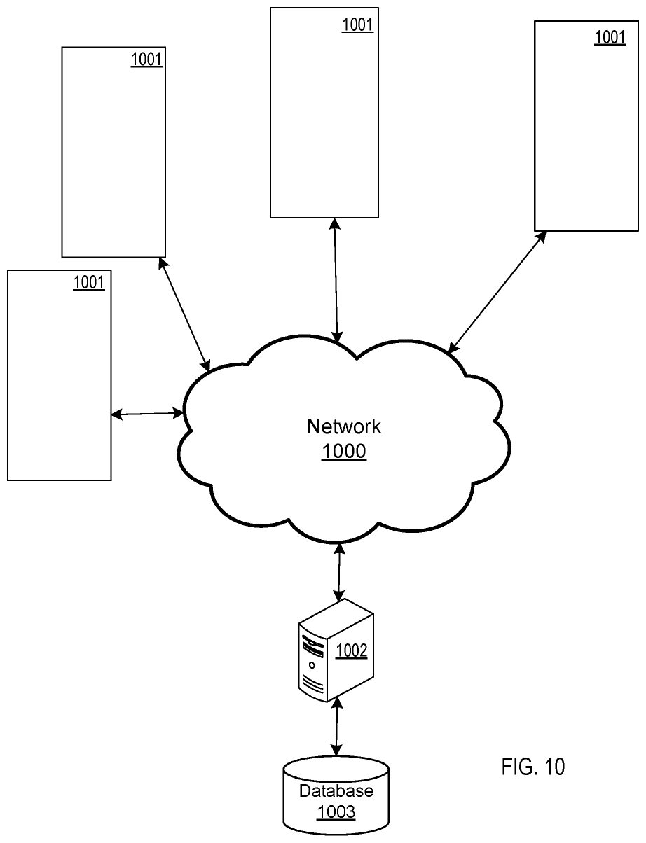

FIG. 10 illustrates a system involving a plurality of shipping containers networked to a management apparatus, in accordance with an example implementation. One or more shipping containers integrated with various sensors 1001 are communicatively coupled to a network 1000 (e.g., local area network (LAN), wide area network (WAN)) through the corresponding network interface of the sensor system installed in the shipping container 1001, which is connected to a management apparatus 1002. The management apparatus 1002 manages a database 1003, which contains historical data collected from the sensor systems from each of the shipping containers 1001. In alternate example implementations, the data from the sensor systems of the shipping containers 1001 can be stored to a central repository or central database such as proprietary databases that intake data from the shipping containers 1001, or systems such as enterprise resource planning systems, and the management apparatus 1002 can access or retrieve the data from the central repository or central database. The sensor systems of the shipping containers 1001 can include any type of sensors to facilitate the desired implementation, such as but not limited to gyroscopes, accelerometers, global positioning satellite (GPS), and so on.

Depending on the desired implementation, the receipt of the plurality of sensor data points is in real time during shipment of the shipping container. For example, if the system of FIG. 10 is confined to a ship transporting the shipping container, then the local area network can provide the plurality of sensor data points in real time to the management apparatus 1002, or it can be transmitted (e.g., via satellite) to a monitoring station. In another example implementation. the plurality of sensor data points can also be received after shipment of the shipping container (e.g., stored in the database of the ship for extraction and processing later at port by the management apparatus 1002 as stored on the ship or at the port).

Further, database 1003 can include additional sensor data points associated with previously shipped shipping containers (e.g., either from the same ship, or as imported from a master database). In example implementations, such additional sensor data points can supplement the plurality of sensor data points from the present shipping containers 1001 if such previously shipped shipping containers were shipped in the same route as the present shipping containers 1001.

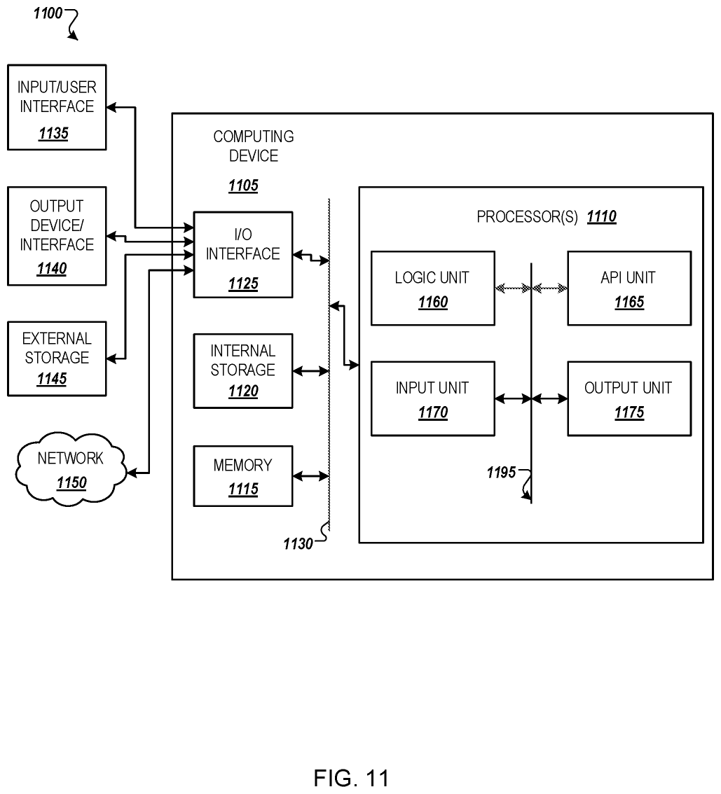

FIG. 11 illustrates an example computing environment with an example computer device suitable for use in some example implementations, such as a management apparatus 1002 as illustrated in FIG. 10. Computer device 1105 in computing environment 1100 can include one or more processing units, cores, or processors 1110, memory 1115 (e.g., RAM, ROM, and/or the like), internal storage 1120 (e.g., magnetic, optical, solid state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, input unit 1170, output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide output based on the calculations described in example implementations.

Processor(s) 1110 can be configured to execute a method or computer instructions involving, for receipt of a plurality of sensor data points associated with one or more sensors of a shipping container, each of the plurality of sensor data points representative of one or more shock measurements at a particular time, executing the clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers as illustrated in FIGS. 4 to 8; and labeling the one or more clusters and the outliers with an associated shock cause based on a comparison of probability density functions of the one or more clusters and the outliers with historical probability density functions associated with shock causes as illustrated in FIG. 9.

Processor(s) 1110 can be configured to execute the method or computer instructions for executing the clustering algorithm to further include, for other ones of the plurality of sensor data points being within a threshold probability of belonging to one of the one or more clusters, associating the other ones of the sensor data points to the one of the one or more clusters as described in FIGS. 4 to 8. Depending on the desired implementation, the clustering algorithm generates the one or more clusters based on a pointwise distance metric between the plurality of sensor data points, the pointwise distance metric chosen based on significance of shock size versus direction. Such a pointwise distance metric can be one of Euclidian distance, rocking distance, and unit-norm distance, depending on the desired implementation.

Processor(s) 1110 can be configured to execute method or computer instructions wherein the labeling the one or more clusters and the outliers with an associated shock cause based on the comparison of probability density functions of the one or more clusters and the outliers with historical probability density functions associated with shock causes involves determining, for each of the one or more clusters and the outliers, a distance between a probability density function of the each of the one or more clusters and the outliers with the historical probability density functions associated with the shock causes; providing a shock cause from the shock causes associated with a historical probability density function from the historical probability density functions having a smallest distance to the probability density function of the each of the one or more clusters and the outliers as the labeling as illustrated in FIG. 8. Depending on the desired implementation, the probability density function of the each of the one or more clusters and the outliers can be associated with a journey segment from a plurality of journey segments based on the particular time of associated ones of the plurality of sensor data points; wherein each of the historical probability density functions associated with the shock causes is associated with a corresponding one of the plurality of journey segments; wherein the determining, for the each of the one or more clusters and the outliers, the distance between a probability density function of the each of the one or more clusters and the outliers with the historical probability density functions associated with the shock causes is conducted between the historical probability density functions having a same corresponding one of the plurality of journey segments as the journey segment from the plurality of journey segments associated with the probability density function.

Depending on the desired implementation, the distance can be a representative of a probability of the probability density function and the each of the historical probability density function belong to a common cause.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a plurality of sensor data points associated with one or more sensors of a shipping container, each of the plurality of sensor data points representative of one or more shock measurements at a particular time:
executing a clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and
labeling the one or more clusters and the outliers with an associated shock cause based on a comparison of probability density functions of the one or more clusters and the outliers with historical probability density functions associated with shock causes.

2. The method of claim 1, wherein the executing the clustering algorithm further comprises for other ones of the plurality of sensor data points being within a threshold probability of belonging to one of the one or more clusters, associating the other ones of the sensor data points to the one of the one or more clusters.

3. The method of claim 2, wherein the clustering algorithm generates the one or more clusters based on a pointwise distance metric between the plurality of sensor data points, the pointwise distance metric chosen based on significance of shock size versus direction.

4. The method of claim 3, wherein the pointwise distance metric is one of Euclidian distance, rocking distance, and unit-norm distance.

5. The method of claim 1, wherein the labeling the one or more clusters and the outliers with an associated shock cause based on the comparison of probability density functions of the one or more clusters and the outliers with historical probability density functions associated with shock causes comprises:
determining, for each of the one or more clusters and the outliers, a distance between a probability density function of the each of the one or more clusters and the outliers with the historical probability density functions associated with the shock causes; and
providing a shock cause from the shock causes associated with a historical probability density function from the historical probability density functions having a smallest distance to the probability density function of the each of the one or more clusters and the outliers as the labeling.

6. The method of claim 5, wherein the probability density function of the each of the one or more clusters and the outliers are associated with a journey segment from a plurality of journey segments based on the particular time of associated ones of the plurality of sensor data points;
wherein each of the historical probability density functions associated with the shock causes is associated with a corresponding one of the plurality of journey segments; and
wherein the determining, for the each of the one or more clusters and the outliers, the distance between a probability density function of the each of the one or more clusters and the outliers with the historical probability density functions associated with the shock causes is conducted between the historical probability density functions having a same corresponding one of the plurality of journey segments as the journey segment from the plurality of journey segments associated with the probability density function.

7. The method of claim 5, wherein the distance is representative of a probability of the probability density function and the each of the historical probability density function belong to a common cause.

8. The method of claim 1, wherein the receipt of the plurality of sensor data points is in real time during shipment of the shipping container.

9. The method of claim 1, wherein the plurality of sensor data points is received after shipment of the shipping container.

10. The method of claim 1, wherein the plurality of sensor data points is supplemented with additional sensor data points associated with previously shipped shipping containers that were shipped in a same route as the shipping container.

11. A non-transitory computer readable medium, storing instructions for executing a process, the instructions comprising:
for receipt of a plurality of sensor data points associated with one or more sensors of a shipping container, each of the plurality of sensor data points representative of one or more shock measurements at a particular time:
executing a clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and
labeling the one or more clusters and the outliers with an associated shock cause based on a comparison of probability density functions of the one or more clusters and the outliers with historical probability density functions associated with shock causes.

12. An apparatus, comprising:
a processor, configured to:
for receipt of a plurality of sensor data points associated with one or more sensors of a shipping container, each of the plurality of sensor data points representative of one or more shock measurements at a particular time:
execute a clustering algorithm on the plurality of sensor data points to generate one or more clusters for one or more of the plurality of sensor data points, the clustering algorithm configured to identify ones of the plurality of sensor data points not meeting a threshold probability of belonging to any of the one or more clusters as outliers; and
label the one or more clusters and the outliers with an associated shock cause based on a comparison of probability density functions of the one or more clusters and the outliers with historical probability density functions associated with shock causes.
